(19) United States
(12) Patent Application Publication
(10) Pub. No.: US 2004/0232684 A1
(43) Pub. Date: Nov. 25, 2004

(54) Method and system for improving child safety on an all-terrain vehicle

(76) Inventor: William E. Curl, Santa Clara, UT (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/795,751

(22) Filed: Mar. 8, 2004

Related U.S. Application Data
(60) Provisional application No. 60/452,746, filed on Mar. 6, 2003.

(51) Int. Cl. B60P 3/071

(52) U.S. Cl. 280/756

(57) ABSTRACT

An all-terrain vehicle child safety system includes a protective cage constructed to house an automobile child safety seat; one or more fasteners for affixing the cage to a solid structure of the all-terrain vehicle; and a connector for engaging the child safety seat in the cage.

### RELATED APPLICATIONS

The present application claims priority under 35 U.S.C. § 119(e) from the following previously-filed Provisional Patent Application, U.S. Application No. 60/452,746, filed Mar. 6, 2003 by William E. Curl, entitled “Method and System for Safely Transporting a Child on an All-Terrain Vehicle Via a Safety Seat System,” and which is incorporated herein by reference in its entirety.

### TECHNICAL FIELD

The present invention relates to the field of all-terrain vehicle safety. More particularly, the present invention relates to a system and method for improving child passenger safety on all-terrain vehicles with a protective cage system designed to contain a conventional child safety seat.

### BACKGROUND

As used herein and in the appended claims, the term All-Terrain Vehicle or “ATV” is used broadly to mean any a variety of recreational or utility vehicles. For example, ATVs include, but are not limited to, three wheelers, four wheelers, six wheelers, snowmobiles, motorcycles, wave runners, go-carts, and the like.

ATVs may be used in a wide variety of applications. For example, the role of ATVs may include ranching, farming, industry, police-work, and mobility for disabled persons. ATVs may also be used as a necessary means of transportation between locations in isolated, mountainous, or remote areas. ATVs can navigate terrain that would not be possible with other conventional modes of transportation.

Safety on all-terrain vehicles (“ATVs”) is a concern for many owners. Consequently, equipment such as helmets, gloves and other protective gear has been used to increase the safety of a rider. Additionally, the design of ATVs has trended toward a focus on increased stability to improve vehicle safety. A number of techniques have been employed in order to improve passenger safety on ATVs.

However, there is always a need for improved safety measures for ATV use, specifically, the protection of child passengers. While being used for recreation or other functional purposes owners may desire to involve younger individuals and family members, or may need to transport a young child on an ATV. In such cases, the need to ensure the safety of these younger individuals while being transported on an ATV is extremely important.

Because of the high level of attention that a driver must give to a young child passenger on an ATV to assure his or her safety, the necessary attentiveness for operating the vehicle may be impaired. This can lead to a hazardous situation for both the operator and the young child. In order to prevent unsafe circumstances such as this, an improved system and method for ensuring both operator and child safety on an ATV is needed.

### SUMMARY

In one of many possible embodiments, the present invention provides a system for improving ATV passenger safety, particularly, transportation of young children. Such a system includes a metal cage that is applied to a solid structure of the ATV. A conventionally safe automobile child safety seat is engaged within the metal cage. As a child is secured in the fastened safety seat, the child is protected from being thrown from the ATV and from being struck by brush, trees or other objects in passing. This allows the operator to be able to fully concentrate on safely maneuvering the ATV.

Another embodiment of the present invention provides a method for making and using the system described above. Specifically, a method of securing a child passenger on an ATV through affixing a child safety seat and metal cage to a solid structure of the ATV is described. This method is performed by connecting the metal cage to the solid structure of the ATV and engaging a child safety seat within the metal cage. The child passenger is further appropriately fastened in the child safety seat. Once this method has been performed the child is protected by the child car seat and surrounding cage. The safety of the child is improved as he or she cannot be thrown from the ATV or otherwise harmed.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a perspective view of the ATV safety system including a child safety seat according to one embodiment of the present invention.

FIG. 2 is a perspective view of the ATV safety system placed on the rear utility rack of an ATV including a child safety seat according to one embodiment of the present invention.

FIG. 3 is a perspective view of the ATV safety system depicting the framework of the metal cage according to one embodiment of the present invention.

FIG. 4 is an illustrated perspective view of the ATV safety system place on the rear utility rack of an ATV including a child safety seat and metal side paneling on the metal cage.

Throughout the drawings, identical reference numbers designate similar, but not necessarily identical, elements.

### DETAILED DESCRIPTION

This specification provides a system and method for improving the safety of a child passenger being transported on an All-Terrain Vehicle (“ATV”). The described system or method decreases the possibility of harm being inflicted on a child passenger while being transported on an ATV by securing the child to the vehicle and surrounding the child with a protective structure. As described herein, a protective metal cage is affixed to a solid structure of the ATV, such as a utility rack. The cage is constructed to house a conventional automobile child safety seat in which a child passenger can be much more safely transported using the ATV.

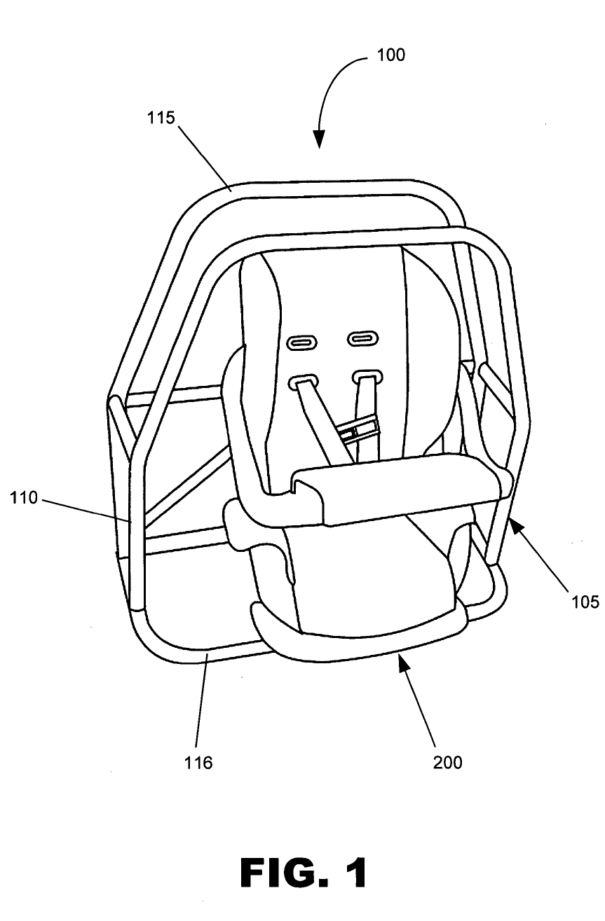

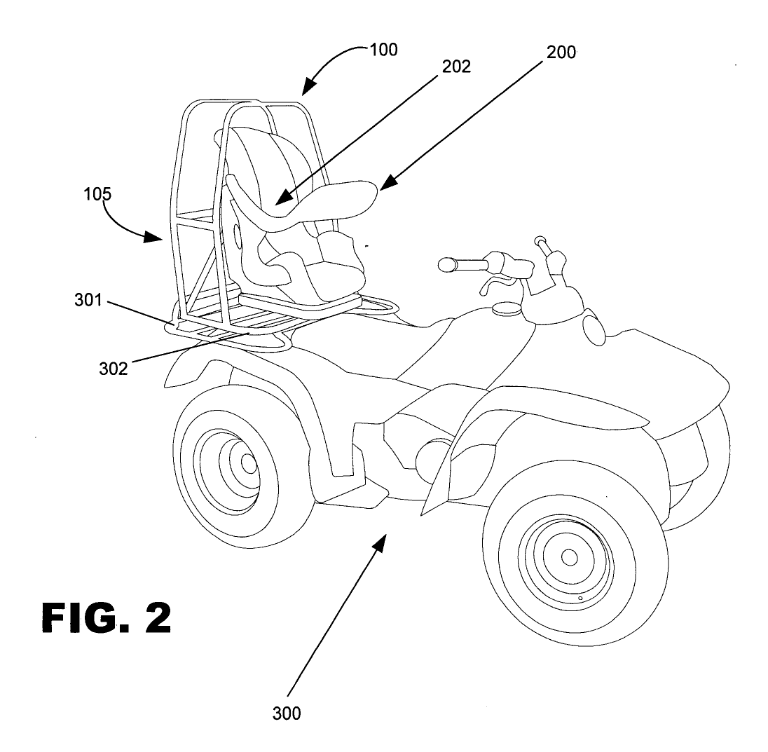

FIG. 1 illustrates one embodiment of the ATV safety system (100) described herein. As shown in FIGS. 1 and 2, the ATV safety system (100) includes a metal cage (105) or framework. The cage (105) can be constructed of metal bars or metal tubing as will be described herein. The cage (105) is constructed to engage and be secured to a solid structure (301), such as a utility rack, on an ATV (300).

Child safety seats for automobiles are known and well designed for securing a child safely while traveling in an automobile. These automobile child safety seats are configured to be secured in an automobile seat using the seat belt typically found in an automobile seat. Once the safety seat is secured to the automobile seat, additional belts in the safety seat are used to belt a child into the safety seat so that the child is held securely and safely within the seat in the event of an automobile accident.

As shown in FIG. 1, the cage (105) of the present safety system is sized to receive and contain an automobile or other child safety seat (200). The seat (200) is secured to the cage (105). For example, the cage (105) may include belts that can be used to secure the child safety seat (200) in the cage (105) in the same manner that such a seat would be secured in an automobile seat.

FIG. 2 illustrates the safety system (100) installed on an ATV (300), in this case a four-wheeler. As shown in FIG. 2, the cage (105) is secured to the rear utility rack (301) of the ATV (300). The child safety seat (200) is removably secured within the cage (105). Consequently, a child can be comfortable seated and secured in the child safety seat (200) for riding on the ATV (300).

An older or adult driver can then operate the ATV (300) with much less concern for the position and safety of the child passenger. Both of the driver's hands will be free to more safely operate the ATV (300) than would be the case if the driver where trying to hold the child passenger. Consequently, the driver of the ATV (300) can focus much more concentration on safely operating the ATV (300) rather than worrying about holding or otherwise protecting or monitoring the child passenger.

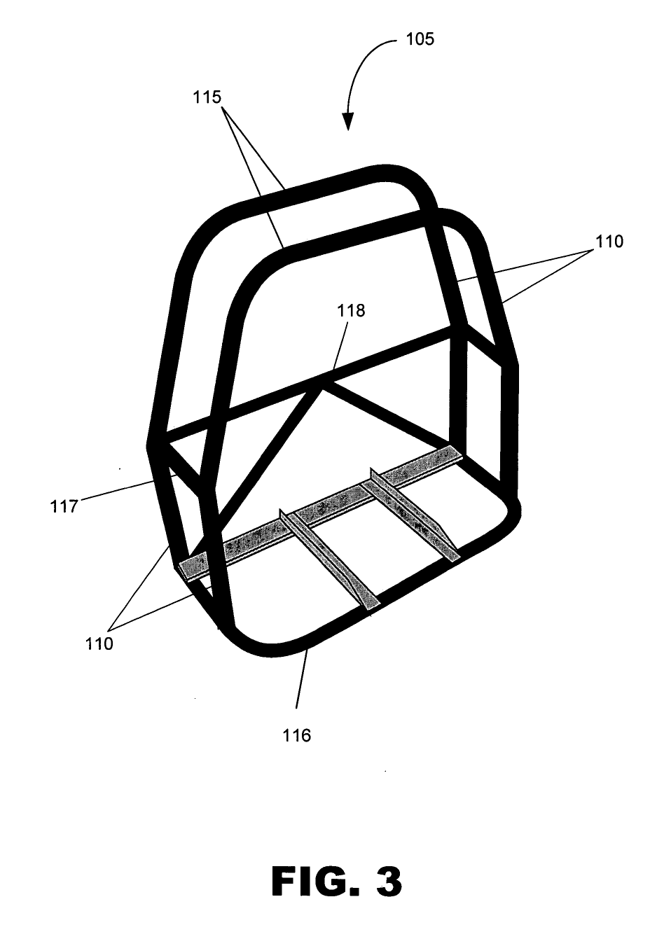

FIG. 3 is an illustration of the metal cage (105) without a child safety seat being installed therein. As shown in FIG. 3, the metal cage (105) may be constructed from a pair of vertical metal tubes (110) on either side of the cage (105) and a pair of horizontal tubes (115) on the top. Those of skill in the art will appreciate that solid bars could be used in an alternative embodiment in place of the tubes described herein.

The vertical tubes (110) may have an elbow near the center of the cage (105) to increase the volume of space enclosed within the cage in which a child safety seat may be disposed. Crossbars (117) may run between the vertical tubes (110) at these elbows for added structural strength.

A back frame (118) of tubes may be constructed at the back of the cage (105) between the vertical tubes (110). This back frame (118) provides a structure against which the child safety seat can rest and to which the child safety seat can be secured. For example, belts for securing the child safety seat to the cage (105) can be secured to the back frame (118), the vertical tubes (110) or the base frame (116).

The base frame (116) can also made of horizontally connected tubes. Although not shown in FIG. 3, the base frame (116) may also incorporate means for securing the cage (105) to a solid structure, such as a utility rack, of an ATV. For example, the base frame (116) may include clamps or brackets that engage and are bolted to a solid structure of an ATV.

The metal tubing of the cage (105) provides a structural housing that protects a child within the child safety seat (200) from any type of crushing blow caused by something such as a rollover.

Returning to FIG. 2, the size of the metal cage (105) is proportionally larger in size compared to that of the child safety seat (200) allowing a protective space between the extremities of the child safety seat (200) and the steel cage (105). This protective space allows the child safety seat (200) to be easily placed in the protective cage (105) and further prevents the child from injuring a limb while extending it beyond the confines of the child safety seat (200).

As described above, the metal cage (105) is affixed to the solid structure (301) of the ATV (300) by means of appropriate fasteners (302). The fasteners (302) can be, for example, nuts and bolts, screws, welds, clamps or other fastening devices or any combination thereof.

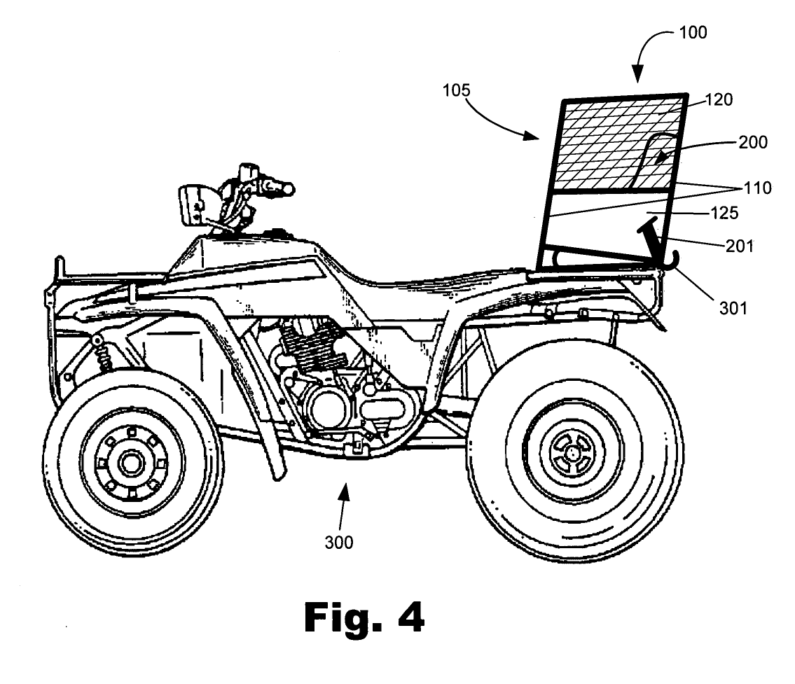

With the child secured in the child safety seat (200) and the child safety seat (200) correctly fastened to the solid structure (301) of the ATV (300) as shown in FIGS. 2 and 4, the child is protected from being ejected from the ATV. The child is also protected from being hit by objects passing the ATV, which could cause injury. Consequently, the safety of the child is improved and the operator is given greater freedom to concentrate on safely maneuvering the ATV.

The method by which the ATV safety system is used is as follows: First, the metal cage (105) is affixed to a solid structure (301) of the ATV (300) as shown in FIGS. 2 and 4 by means of any of the described fastening devices. Next, a child safety seat (200) is placed within the framework of the metal cage (105) on the base (116) and a safety belt (201, FIG. 4) or other connector secured to the metal cage (105) is used to securely latch the child safety seat (200) within the cage (105).

Finally, the child is placed in the safety seat (200) and buckled in using the safety straps (202) on the child safety seat. If the ATV is operated in this arrangement the child is protected from injury and the operator is allowed to direct most or all of his or her attention to the safe operation of the ATV, where more of the driver's attention would have otherwise been given to the child passenger.

As shown in FIGS. 2 and 3, the cage (105) described herein can be formed solely by the metal bars or tubing as described. This configuration permits the child in the safety seat to have an unobstructed view to either side to experience a wind or breeze as the ATV moves. However, it also leaves the child less protected from the intrusion of branch or other object the ATV may be passing.

Consequently, in an alterative embodiment, the cage (105) maybe more enclosed than illustrated in FIGS. 2 and 3. For example, a wire mesh or screen or a chain link screen can be placed over the framework of the cage (105) to partially or fully enclose the cage (105). Alternatively, a light-weight sheet metal can be used to partially or fully enclose the cage (105). Such enclosing members may also be used in combination.

As shown in FIG. 4, lightweight expanded metal (120) such as a mesh or screen and a lightweight sheet metal (125) are used as paneling on the top and bottom halves, respectively, between the vertical tubes (110) on the sides and rear of the cage (105). IN some embodiments, the metal paneling may be disposed only on the sides of the cage (105). This metal paneling (120, 135) protects the child passenger in the cage (105) from being struck by a passing object such as a bush or tree limb. This metal paneling also protects a child by preventing him or her from extending a limb beyond the metal cage (105) boundary where it can be struck and injured by an object in passing.

FIG. 4 also shows a safety belt (201) or other connector that is fastened to the metal cage (105) in a position so as to tightly fasten a child safety seat in place within the metal cage (105) just as an automobile safety belt would fasten a child safety seat within an automobile seat. In addition to the automotive seat belt (201), appropriately placed anchor points are connected to or formed on the metal cage (105) for the latches of a latch-equipped child safety seat (200) to anchor to. The anchor points can be used in conjunction with, or in place of, the automotive seat belt (201) to tightly fasten a specific model of a child safety seat (200) in place within the metal cage (105).

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. An all-terrain vehicle child safety system comprising:
a protective cage constructed to house an automobile child safety seat;
one or more fasteners for affixing said cage to a solid structure of said all-terrain vehicle; and
a connector for engaging said child safety seat in said cage.

2. The system of claim 1, wherein said solid structure of said all-terrain vehicle is a utility rack.

3. The system of claim 1, wherein said cage comprises a framework composed of metal tubing.

4. The system of claim 3, wherein said framework comprises connecting horizontal and vertical portions of said metal tubing.

5. The system of claim 1, wherein said protective cage comprises a framework enclosed at least partially by paneling.

6. The system of claim 5, wherein said paneling comprises sheet metal.

7 The system of claim 5, wherein said paneling comprises a mesh or screen.

8. The system of claim 1, wherein said connector is a safety belt affixed to said cage.

9. The system of claim 1, wherein said connector comprises one or more anchor points on said cage appropriately located to be engaged by a latch system of a latch-equipped child safety seat.

10. A method of safely transporting a child on an all-terrain vehicle, said method comprising securing said child in an automobile child safety seat that is secured in a protective cage secured to said all-terrain vehicle.

11. The method of claim 10, further comprising securing said child safety seat within said cage system using a belt.

12. The method of claim 10, further comprising fastening said cage to a utility rack on said all-terrain vehicle.

13. The method of claim 12, wherein said fastening comprises bolting said cage to said rack.

14. The method of claim 12, wherein said fastening comprises clamping said cage to said rack.

15. The method of claim 12, wherein said fastening comprises welding said cage to said rack.

16. The method of claim 10, further comprising at least partially enclosing said protective cage with paneling.

17. The method of claim 16, wherein said paneling comprises sheet metal.

18. The method of claim 16, wherein said paneling comprises a wire mesh or screen.

19. An all-terrain vehicle child safety system comprising:
a protective cage constructed to house an automobile child safety seat;
means for fastening said cage to a solid structure of said all-terrain vehicle; and
means for securing said child safety seat in said cage.

20. The system of claim 19, wherein said all-terrain vehicle is a four-wheeler.
